(19) United States
(12) Patent Application Publication
(10) Pub. No.: US 2023/0204753 A1
(43) Pub. Date: Jun. 29, 2023

(54) Method, System and Apparatus for Generating an Optimal Signal in Radar and Communication Systems

(71) Applicant: MMRFIC Technology Pvt. Ltd., Bangalore (IN)

(72) Inventors: Ganesan Thiagarajan, Bengaluru (IN); Saravanakumar Ganeshan, Bengaluru (IN); Sanjeev Gurugopinath, Bengaluru (IN)

(73) Assignee: MMRFIC Technology Pvt. Ltd., Bangalore (IN)

(21) Appl. No.: 18/086,676

(22) Filed: Dec. 22, 2022

(30) Foreign Application Priority Data
Dec. 23, 2021 (IN) 202141028307

(51) Int. Cl. G01S 13/58; G01S 7/00; G01S 7/282; H04L 5/00

(52) U.S. Cl. CPC G01S 13/582; G01S 7/006; G01S 7/282; H04L 5/0048

(57) ABSTRACT

A method of generating a reference signal for transmission over a wireless communication channel comprises generating a first signal of a first characteristic, generating a second signal with second characteristic, scaling the second signal at least in time and an amplitude to form a scaled signal and iteratively adding the scaled signal to the first signal to generate the reference signal. The iteratively adding comprises time indexing the first signal with plurality of time points, adding the scaled signal to first signal at each time point in the plurality of time points, computing a cost function to determine the cost of adding the scaled signal at each time point in the plurality of time points, selecting a set of time points that indicate reduction in the cost when the scaled signal is added and adjusting the amplitude of the scaled signal at each time point in the set of time points to reduce the cost.

### BACKGROUND

### Field of Invention

This application claims priority from Indian Patent Application No.: 202141028307 filed on Dec. 23, 2021 which is incorporated herein in its entirely by reference.

### Technical Field

Embodiments of the present disclosure relate to communication system and more particularly relate to system, method and apparatus for transmitting an optimal signal in a radar and communication systems.

### RELATED ART

In a communication system or a radar system (used interchangeably in this specification) one or more signals (often referred to as reference signal/carrier signal) with certain characteristics and properties are transmitted and received. The properties and characteristics (commonly referred to as properties) of the signal often assist in efficient information transmission and retrieval even after it has been impacted with operating conditions. The signals are formed based on the type of information that is required to be carried/retrieved over a communication channel. Generally, the communication channel presents several challenges in preserving the information when being transmitted. Accordingly, in the communication system, the parameters of the signals are so selected and signals are formed based on the type of information, channel limitations and the desired performance of the communication system. Often electronic circuitry and components (hardware), signal processing techniques, power, bandwidth etc., of a communication system are altered/optimized to achieve enhanced/higher performance.

### SUMMARY

According to an aspect a method of generating a reference signal for transmission over a wireless communication channel comprises generating a first signal of a first characteristic, amplitude to form a scaled signal and iteratively adding the scaled signal to the first signal to generate the reference signal.

According to another aspect, iteratively adding comprises time indexing the first signal with plurality of time points, adding the scaled signal to first signal at each time point in the plurality of time points, computing a cost function to determine the cost of adding the scaled signal at each time point in the plurality of time points, selecting a set of time points that indicate reduction in the cost when the scaled signal is added and adjusting the amplitude of the scaled signal at each time point in the set of time points to reduce the cost.

According to another aspect, the method comprises testing the reference signal for bandwidth expansion at every time point in the set of time points and the amplitude selected, and by performing iterative filtering of the reference signal in the time and frequency domains alternatively to limit the bandwidth and time when either of them exceeds a threshold.

According to another aspect, the method is applied to generating a radar signal, in that, the cost function is one of the range target ambiguity function such as range ambiguity, velocity target ambiguity function, and Angle of Arrival (AoA) ambiguity function of Radar.

According to another aspect, a radar system is provided and the radar system comprises, a radar signal generator generating a radar signal, a transmitter transmitting the radar signal, a receiver receiving the radar signal reflected from plurality of objects and a range velocity position detector (RVP) detecting the range, velocity and position of the plurality of objects with a corresponding range target ambiguity function, velocity target ambiguity function, and Angle of Arrival ambiguity function, wherein, the radar signal is sum of a first signal and a second signal, the second signal added to first signal at plurality of time points in the first signal.

According to another aspect, the radar signal generator is comprising the first signal generator, second signal generator, an amplitude and time scaling unit operative to scale the second signal in time and amplitude, an adder adding the scaled second signal to the first signal at plurality of time points in the first signal. According to another aspect the adder adds the second signal only at first set of points in the plurality of time points that improve either or all ambiguity functions.

### BRIEF DESCRIPTION OF DRAWINGS

FIG. 1 is an example environment in which several aspects of the present invention may be seen.

FIG. 2 is an example Radar transceiver for object detection and recognition in an embodiment.

FIG. 3A illustrates the narrow correlation property and its benefit.

FIG. 3B is a block diagram illustrating the radar signal generator 230 in one embodiment

FIG. 4 is a block diagram 400 illustrating the generation of reference signal with narroe correlation property in an embodiment.

FIG. 5 is a block diagram 500 illustrating the manner in which the scaled signal may be added to the first signal in one embodiment.

FIG. 6 is a set of graphs illustrating the operations of block 400 and 500.

FIG. 7 illustrates the difference between the autocorrelation of the reference signal and the first signal.

### DETAILED DESCRIPTION OF THE PREFERRED EXAMPLES

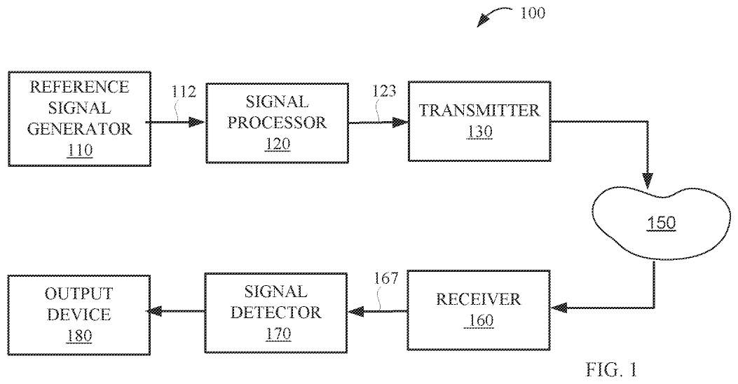

FIG. 1 is an example environment in which several aspects of the present invention may be seen. The environment 100 is shown comprising a reference signal generator 110, signal processor 120, transmitter 130, channel 150, receiver 160, signal detector 170, and output device 180. Each element is further described below.

The reference signal generator 110 generates a reference signal for transmission over the channel 150. The reference signal may be provided on path 112 for processing. The signal processor 120 processes the reference signal for transmission. The signal processor 120 may perform operations such as signal modulation, signal transformations, encoding/decoding, adding time delays, filtering, up-conversion/down-conversion (frequency translation) etc., as is well known in the art. The processed signal is provided on path 123.

The transmitter 130 transmits the processed signal received on path 123. The transmitter may perform signal condition operation (like amplify and transform the received signal to analog form)on the signal for transmission over the channel 150. The transmitter 130 may comprise antennas for transmission over a wireless channel or free space. In certain embodiment, the transmitter 130 may be implemented in accordance with the protocols (like 5G) of certain communication/radar standards.

The receiver 160 operates in conjunction with the transmitter 130 to receive the signal from the channel 150 and provides the received signal to the decoder 170 on path 167. The decoder 170 performs several signal processing operations to extract the reference signal. While in certain embodiments, one or more comparison operations are performed on the received reference signal to the transmitted reference signal to determine the relevant information, in certain other embodiment, certain operations are performed on the received reference signal to extract the information. Thus, the reference signal plays important role in the performance of the communication system.

Accordingly, in one embodiment, the reference signal generator 110 generates a signal with parameters that is capable of enhancing the performance of the communication system. A radar system, as an example communication system is further described below illustrating several aspects in one embodiment.

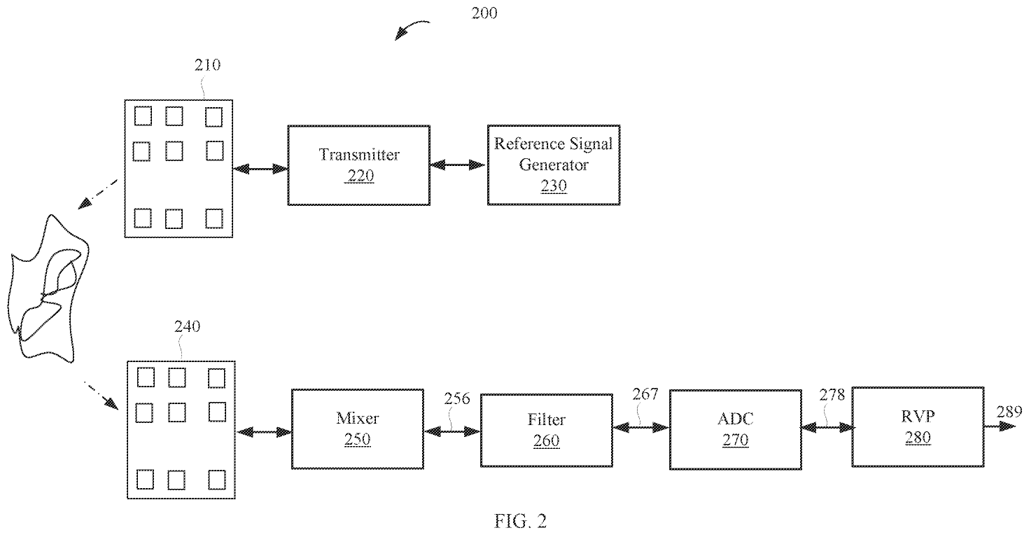

FIG. 2 is an example Radar transceiver for object detection and recognition in an embodiment. The Radar transceiver 200 is shown comprising transmitting antenna 210, transmitter block 220, reference (radar) signal generator 230, receiving antenna array 240, mixer 250, filter 260, analog to digital convertor (ADC) 270 and Range Velocity and Position extractor (RVP) 270. Each element is described in further detail below.

In one embodiment, a radar signal generator 230 generates the radar signal (the reference signal like in 110) and provides the same to the transmitter 220. The transmitter 220 arranges/selects the transmitting antennas for transmitting the radar signal and provides the same to the transmitting antenna array 210 for transmission. The receiving antenna array 240 receives reflected radar signal (that is the radar signal reflected from plurality of objects).

The Mixer 250 mixes radar signal received on receiving antenna array 220 with the first signal to generate an intermediate frequency signal (IF signal/base band signal). The intermediate frequency signal is provided on path 256 to filter 260. The filter 260 passes the IF signal attenuating the frequency components outside the band of interest (such as various harmonics) received from the mixer.

The ADC 270 converts IF signal received on path 267 (analog IF signal) to digital IF signals. The ADC 270 may sample the analog IF signal at a sampling frequency Fs, and may generate a samples of the IF signal and convert each sample value to a bit sequence or binary value. The digitised samples of IF signal (digital IF signal) is provided for further processing on path 278 to RVP 280.

The Range Velocity and Position extractor (RVP) 280 is configured to extract the range, the velocity/relative velocity and the position (azimuth and/or elevation) of the object from the samples received on the path 278. In one embodiment, the RVP 280 provides an enhanced Doppler range resolution on path 289.

In one embodiment, the RVP 280 may perform autocorrelation of received radar signal with the reference radar signal to determine the objects, distance and velocity. That is RVP 280 may estimate range by measuring the round trip delay between the transmitted pulse (reference signal) and received reflections and estimate the relative velocity of the target by measuring the phase difference between consecutive pulses separated by Pulse Repetition Interval (PRI).

The correlation properties of the transmitted radar signal is crucial to distinguish targets which are closer in space. Many pulses/signals are employed in practice: e.g., Rectangular/Gaussian pulse modulating a sinusoid carrier, Rectangular/Gaussian pulse modulating an FMCW carrier, etc. The smallest correlation lag for which the auto-correlation of the given Tx pulse waveform goes to a small value (say, a fractions of the maximum correlation value, 10% of Maximum correlation value for example) determines the smallest distance that can be differentiated between two targets.

Accordingly, the reference (radar) signal generator 230 is configured to generate a reference signal that exhibits sharp or narrow correlation property (that is the signal has small correlation lag). Such sharp correlation property enhances the resolution of the radar system without requiring to enhance the bandwidth, or power of the radar system.

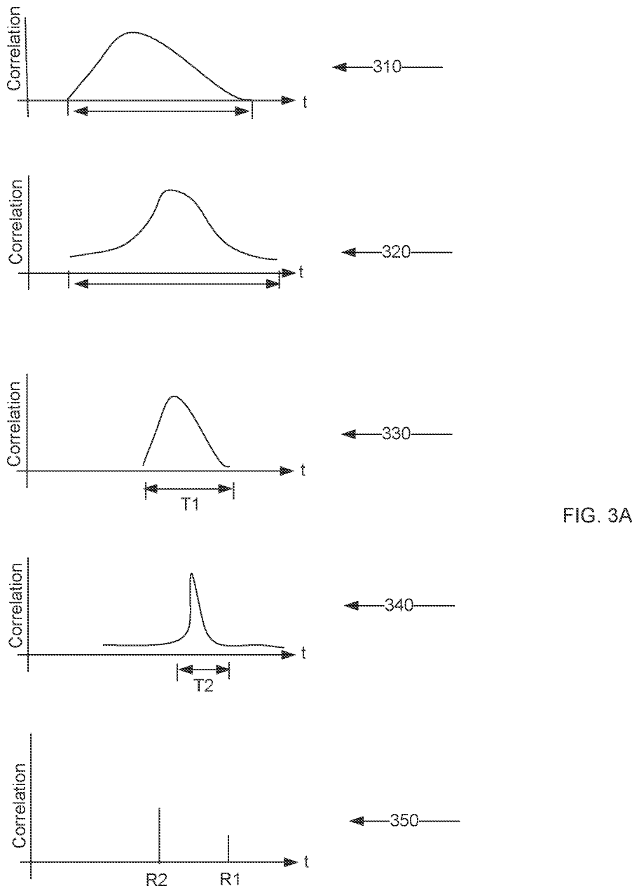

FIG. 3A illustrates the narrow correlation property and its benefit. As shown there, the curve 310 represents a signal with long correlation property and curve 320 represents signal with the sharp correlation property. As shown there, the autocorrelation 330 of the signal 310 is shown having time period T1. Similarly the autocorrelation 340 of signal 320 is shown having time period T2.

The graph 360 illustrates example objects and the range. The effect of narrow correlation property is illustrated with two objects O1 and O2 that are shown at range R1 and R2 respectively. It may be appreciated that, object O2 may be detected using signal 320 as its correlation width T2 is less than the difference of the range R1˜R2 (in time). Accordingly, the reference signal generator 230 generates the radar signal with narrow correlation property thus, enhancing the resolution of the radar signal.

FIG. 3B is a block diagram illustrating the radar signal generator 230 in one embodiment. The radar signal generator 351 is shown comprising a primary signal generator 361, second signal generator 362, an amplitude and time scaling unit 363, processor 364 and adder 365. In that, the primary signal generator 361 generates a finite time, finite power and smooth signal that is continuous. For example, primary signal generator may generate a Gaussian pulse/Gaussian shaped tone. Similarly, the second signal generator 362 generates another finite time, finite power and smooth signal that is continuous. For example the second signal generator 362 may generate a raised cosine pulse. The amplitude and time scaling unit 363 is operative to scale the second signal in time and amplitude. The amplitude and time scaling unit 363 may perform scaling operation iteratively and store the performance of the added signal for reference. The adder 365 is configured to add the scaled second signal to the first signal at plurality of time points in the first signal. The adder 365 provides the added signal as radar signal. The processor 364 monitors the added signal on path 399 to adjust the amplitude scaling factor and timing of addition by providing control signal to the amplitude and time scaling unit 363 and adder 365. In one embodiment, the processor may adopt or compute one or more cost function to determine the cost of adding and scaling.

Conventionally, the signal with small correlation lag is achieved by generating sharp pulses (pulse width of shorter time duration). Such narrow pulse width generally results in increased bandwidth requirement. Other conventional technique uses pseudo random sequences to achieve the sharp auto correlation property. However, the pseudo-random sequences require large memory to store the sequence as well as large bandwidth. Another conventional technique uses chirps (a signal with linearly varying frequency) of longer duration or higher slope. Such chirps again require higher bandwidth. Yet another conventional technique uses MIMO (multi input and multi output) antenna structure. In case of MIMO the complexity is in the spatial domain. That is, in addition to bandwidth requirement, additional hardware in terms of antennas and processing is required to be implemented.

In one embodiment, at least some of the disadvantages noted above in respect of the conventional techniques are overcome by generating a reference signal with sharp correlation property to enhance the resolution of the radar system. In one embodiment, a waveform is optimised for transmission by modifying it using another waveform in small steps.

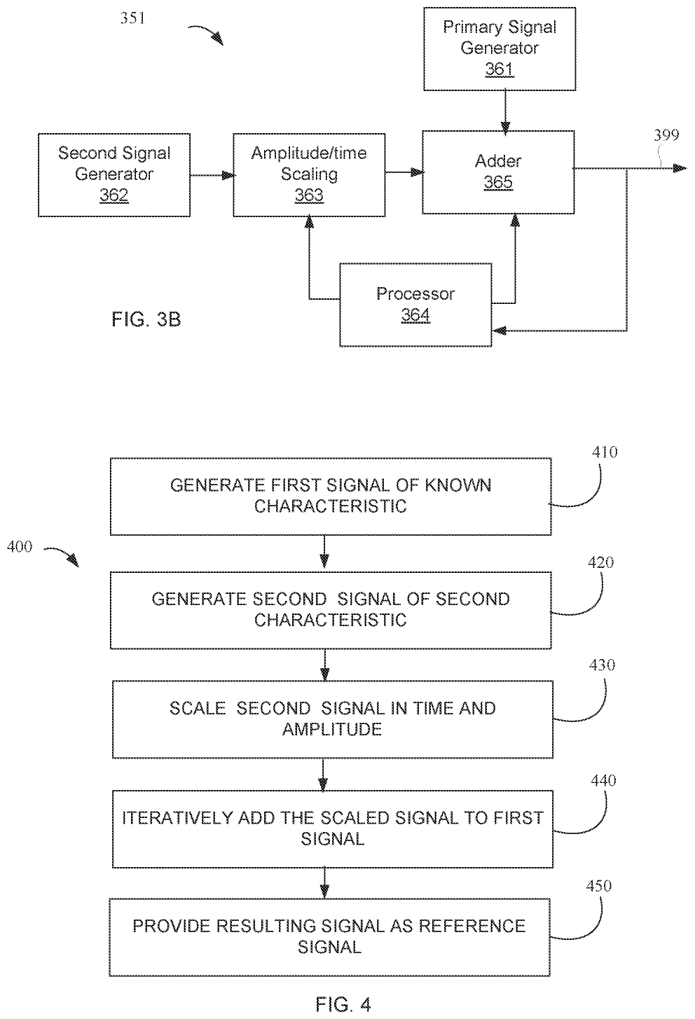

FIG. 4 is a block diagram 400 illustrating the generation of reference signal with sharp correlation property in an embodiment. In block 410, a first signal of known characteristic is generated. For example, one of a known signal such as rectangular pulse, raised cosine pulse, Gaussian Pulse etc., may be selected as first (primary) signal. In one embodiment, a known waveform that meets the constraints such as time duration T (in which it is required to be non-zero), maximum allowed bandwidth (B) and smoothness such as continuously differentiable, etc., is selected as primary signal. The signals that meet criteria are Gaussian pulse between −T/2 and T/2 and Truncated Sinc pulse between −T/2 and T/2, for example.

In block 420, a second signal with second characteristic is generated. For example, any of the known signal such as one listed above may be selected as second signal. In one embodiment, the primary signal may also be selected as secondary signal with same or different properties like amplitude, bandwidth, pulse width etc. In one embodiment, the second signal is selected such that its parameters meet the optimality condition given by Euler-Lagrangian equation for iterative convergence of function optimization as in the Calculus of variations, a well known art. In one embodiment, both primary signal and the second signal may be Gaussian pulse between −T/2 and T/2.

In block 430, the second signal is time and/or amplitude scaled to generate a time/amplitude scaled signal (generally referred to as scaled signal). The scaling may be performed by first attenuating the second signal by passing through an attenuator, followed by compressing the signal in time using any known techniques such as down sampling and/or re-sampling. In certain embodiment, the second signal may be compressed only in time.

In block 440, the scaled signal is iteratively added to the first signal to generate the reference signal with sharp correlation property. In one embodiment, a cost function is selected for and scaled signal is iteratively added such that, the cost reduces over a range. For example, the cost function can be chosen as the correlation lag values reduction in a given range. The cost function can be selected as a function of the independent variable (t), the function f(t) and its derivative f′(t), wherein, f(t) is the final reference waveform arrived by adding the first and second signals with suitable amplitude and time scaling.

Further in an alternative embodiment, additional constraints may be added to limit the bandwidth expansion while iteratively adding (modifying) the primary waveform. The cost/bandwidth check may be performed at every step for reduction in cost function and/or the check may be performed at every step to limit the maximum allowed bandwidth of the signal (reference signal) and/or the check may be performed for convergence to terminate the iteration. In block 450, the generated reference signal is provided as radar signal for transmission and object detection. The manner in the scaled signal may be iteratively added to the primary signal in an embodiment is further described below.

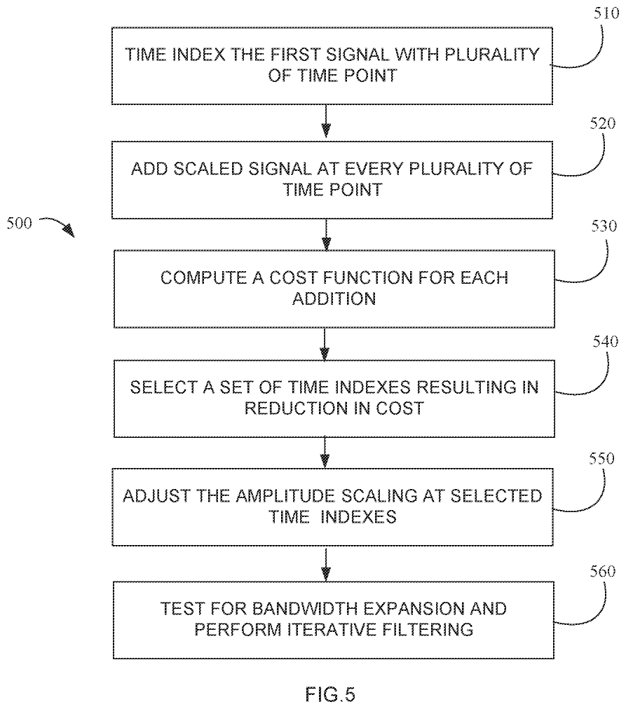

FIG. 5 is a block diagram 500 illustrating the manner in which the scaled signal may be added to the first signal in one embodiment. In the block 510, the first signal is time indexed with plurality of time points. The plurality of time points may be selected such that the difference between two successive time points may be small time duration (δt) for the given sampling rate Fs. In one embodiment, δt may be selected such that, at least a certain number of samples are available within the time duration δt. That is, δt may be selected based on sampling/operating frequency of the ADC 570.

In the block 520, the scaled signal is added to first signal at each time index point at a time. In block 530, a cost function is computed to determine the cost of combining (adding) the signal at each time index. That is, for every relative time shift, the optimality condition is determined, if the cost function does not reduce, then next time point in the sequence is considered for adding.

In bock 540, a set of time indexes are selected that indicate enhanced performance (reduction in cost). In block 550, amplitude of the second signal is adjusted at each selected time point to optimise the cost function. That is, for every selected optimal time shift, the amplitude scale is changed and checked for cost function reduction. The amplitude scale which gives maximum reduction in the cost function is selected for addition.

In bock 560, for every optimal time shift and amplitude scale selected, the added or combined signal is tested for bandwidth expansion. If the bandwidth exceeds a threshold, the bandwidth is limited by performing truncation in time and frequency domains alternatively. This process is known to converge. This process of addition of second signal to primary signal is performed until a desired cost function reduction is achieved. The operations of blocks 400 and 500 are further illustrated below.

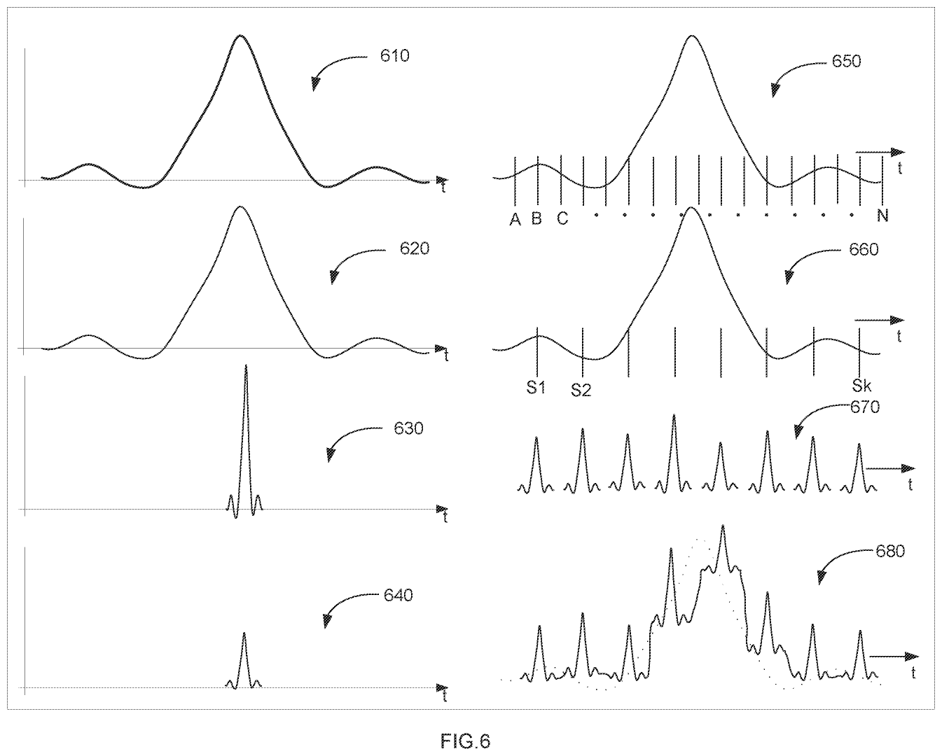

FIG. 6 is a set of graphs illustrating the operations of block 400 and 500. In that, the curve 610 represents a first signal (or primary signal) selected for generating the reference signal. The curve 620 represents the second signal selected for scaling and adding to the first signal 610. The curve 630 represents the time scaled version of the second signal 620. The curve 640 represents the amplitude scaled version of the signal 630. The curve 650 represents the first signal 610 with plurality of time index points A-N. The curve 660 represents the first signal with selected time indexes S 1-Sk. The curve 670 represents the set of time and amplitude scaled second signal for adding at the selected time indexes S 1-Sk. The curve 680 is the reference signal that is the result of adding the signal 670 to signal 610 at time indexes S 1-Sk.

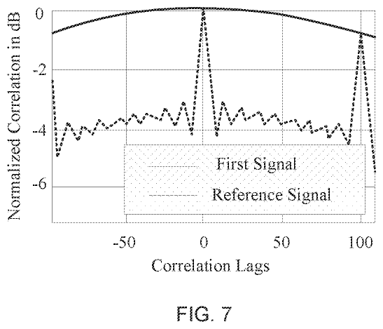

FIG. 7 illustrates the difference between the autocorrelation of the reference signal and the first signal. As may be seen, the autocorrelation of the first (primary signal) exhibit higher correlation values at selected lags of importance compared to that of the optimised reference signal.

In one embodiment, the cost function may be selected to minimize the mean square error in the estimation of range, velocity and position (that is azimuth, elevation or angle of arrival) by RVP 280. Accordingly, cost function may be one of a range target ambiguity function RTAF=E({\dot{x}ᵢ, Rₙ⁻¹\dot{x}ⱼ}), velocity target ambiguity function VTAF=E({\ddot{x}ᵢ, Rₙ⁻¹\ddot{x}ⱼ}), and Angle of Arrival (AoA) ambiguity function AoATAF=E({\dot{x}ᵢ·Øᵢ, Rₙ⁻¹\dot{x}ⱼ·Øⱼ}) as is known in the field of art of Radar. In an alternative embodiment, the cost function may be weighted sum of all three cost functions: J=αE({\dot{x}ᵢ, Rₙ⁻¹\dot{x}ⱼ})+βE({\ddot{x}ᵢ, Rₙ⁻¹\ddot{x}ⱼ})+γE({\dot{x}ᵢ·Øᵢ, Rₙ⁻¹\dot{x}ⱼ·Øⱼ}), wherein α+β+γ=1. wherein α, β and γ represent the scaling constants, E(x) denotes the expectation operation (averaging) over all possible values of x, Rₙ⁻¹ is the inverse of the spatial noise covariance matrix and \dot{x} denotes the time derivative of x, \ddot{x} denotes the second derivative of x “and Øᵢ denote a phasor array whose components are the derivatives of the received signal's (at each array element) phase with respect to the angle of arrival.

As may be appreciated systematic procedure provides above constructs the optimal transmit waveform with narrow/sharp correlation or least correlation lag. The waveform exhibits a structure unlike pseudo-random waveforms. A desired correlation property may be obtained at specific lag positions of choice. Thus improving the performance of the Radar, just by changing the pulse-shape.

Though the waveform optimisation is described with respect to transmitter and transmitted signal, the waveform may be optimized for the reflected pulse by considering the channel between the Tx and Rx as well, if the channel is known apriori, without deviating from the techniques disclosed. The techniques may be applied to radar systems such as Pulsed and FMCW, mono-static and multi-static. Similarly, the techniques may be applied to wireless communication system. For example, multi-path dominated wireless communication may use these waveforms as training sequences, waveform to resolve multi-paths like in CDMA systems and channel specific waveform adaptation for optimal performance.

While various embodiments of the present disclosure have been described above, it should be understood that they have been presented by way of example only, and not limitation. Thus, the breadth and scope of the present disclosure should not be limited by any of the above-discussed embodiments but should be defined only in accordance with the following claims and their equivalents.

What is claimed is:

1. A method of generating a reference signal for transmission over a wireless communication channel comprising:
generating a first signal of a first characteristic;
generating a second signal with second characteristic;
scaling the second signal at least in time and an amplitude to form a scaled signal; and
iteratively adding the scaled signal to the first signal to generate the reference signal.

2. The method of claim 1, further comprising:
time indexing the first signal with plurality of time points;
adding the scaled signal to first signal at each time point in the plurality of time points;
computing a cost function to determine the cost of adding the scaled signal at each time point in the plurality of time points;
selecting a set of time points that indicate reduction in the cost when the scaled signal s added; and
adjusting the amplitude of the scaled signal at each time point in the set of time points to reduce the cost.

3. The method of claim 2, further comprising testing the reference signal for bandwidth expansion at every time point in the set of time points and the amplitude selected, and by performing iterative filtering of the reference signal in the time and frequency domains alternatively to limit the bandwidth when the bandwidth exceeds a threshold.

4. The method of claim 3, where in the reference signal is a radar signal.

5. The method of claim 4, wherein the cost function is one of a range target ambiguity function RTAF=E({\dot{x}ᵢ, Rₙ⁻¹\dot{x}ⱼ}), velocity target ambiguity function VTAF=E({\ddot{x}ᵢ, Rₙ⁻¹\ddot{x}ⱼ}), and Angle of Arrival (AoA) ambiguity function AoATAF=E({\dot{x}ᵢ·Øᵢ, Rₙ⁻¹\dot{x}ⱼ·Øⱼ}) of Radar.

6. The method of claim 5, wherein the cost function is weighted sum of RTAF, VTAF and AoATAF represented as: J=αE({\dot{x}ᵢ, Rₙ⁻¹\dot{x}ⱼ})+βE({\ddot{x}ᵢ, Rₙ⁻¹\ddot{x}ⱼ})+γE({\dot{x}ᵢ·Øᵢ, Rₙ⁻¹\dot{x}ⱼ·Øⱼ}), wherein α+β+γ=1.

7. A radar system comprising:
a radar signal generator generating a radar signal:
a transmitter transmitting the radar signal;
a receiver receiving the radar signal reflected from plurality of objects; and
a range velocity position detector (RVP) detecting the range, velocity and position of the plurality of objects with a corresponding range target ambiguity function RTAF=E({\dot{x}ᵢ, Rₙ⁻¹\dot{x}ⱼ}), velocity target ambiguity function VTAF=({\ddot{x}ᵢ, Rₙ⁻¹\ddot{x}ⱼ}), and Angle of Arrival (AoA) ambiguity function AoATAF,
wherein, the radar signal is sum of a first signal and a second signal, the second signal added to first signal at plurality of time points in the first signal.

8. The method of claim 7, wherein the radar signal generator is comprising the first signal generator, second signal generator, an amplitude and time scaling unit operative to scale the second signal in time and amplitude, an adder adding the scaled second signal to the first signal at plurality of time points in the first signal.

9. The method of claim 7, wherein the adder adds the second signal only at first set of points in the plurality of time points that reduce RTAF, VTAF and AoATAF.

10. A method, system, and apparatus for radar receiver system comprising one or more features described in the specifications and drawings.
